(19) United States
(12) Patent Application Publication
(10) Pub. No.: US 2018/0061416 A1
(43) Pub. Date: Mar. 1, 2018

(54) AUTOMATED LANGUAGE LEARNING

(71) Applicant: International Business Machines Corporation, Armonk, NY (US)

(72) Inventors: Corville O. Allen, Morrisville, NC (US); Joseph N. Kozhaya, Morrisville, NC (US)

(21) Appl. No.: 15/252,622

(22) Filed: Aug. 31, 2016

(51) Int. Cl. G10L 15/26; G10L 25/63; G09B 5/04

(52) U.S. Cl. CPC G10L 15/26; G09B 5/04; G10L 25/63

(57) ABSTRACT

A method, executed by a computer, includes receiving a personality profile for a user, prompting a user to speak an utterance comprising one or more words, wherein the utterance is selected from a library of utterances based on the personality profile for the user, and converting a recording of a user speaking the utterance to recognition data. The method may also include selecting a next utterance based on the recognition data and the personality profile for the user. The next utterance may be selected from a library of utterances. Selecting a next utterance may include selecting an utterance corresponding to an action such as repeating, rephrasing, contrasting, elaborating, summarizing, providing a different context, and adjusting a difficulty level. A computer system and computer program product corresponding to the above method are also disclosed herein.

### BACKGROUND

The present invention relates generally to the field of language learning, and more particularly to automated language learning.

Learning a new language is not easy. Traditional approaches such as classroom instruction and tutoring are time consuming and often very expensive. In response to this issue, a number of language learning software applications have been developed to assist users in the language learning process. However, conventional language learning programs typically use the same methodology to teach all users and are not as effective as human tutors.

### SUMMARY

A method, executed by a computer, includes receiving a personality profile for a user, prompting a user to speak an utterance comprising one or more words, wherein the utterance is selected from a library of utterances based on the personality profile for the user, and converting a recording of a user speaking the utterance to recognition data. The method may also include selecting a next utterance based on the recognition data and a personality profile for the user. Selecting a next utterance may include selecting an utterance corresponding to an action such as repeating, rephrasing, contrasting, elaborating, summarizing, providing a different context, and adjusting a difficulty level. A computer system and computer program product corresponding to the above method are also disclosed herein.

### BRIEF DESCRIPTION OF THE DRAWINGS

FIG. 1 is a block diagram depicting one example of a language learning environment wherein at least one embodiment of the present invention may be deployed;

FIG. 2 is a flowchart depicting one example of a language learning method in accordance with at least one embodiment of the present invention;

FIG. 3A is a table diagram depicting one example of a prompt table in accordance with at least one embodiment of the present invention;

FIG. 3B is a table diagram depicting one example of a relevant attributes table in accordance with at least one embodiment of the present invention;

FIG. 3C is a table diagram depicting one example of a next action scoring table in accordance with at least one embodiment of the present invention;

FIG. 4A is a speech recognition lattice in accordance with at least one embodiment of the present invention;

FIG. 4B is a table diagram depicting one example of user pronunciation scores in accordance with at least one embodiment of the present invention;

FIG. 5 is a block diagram depicting one example of a computing apparatus (e.g., cloud computing node) suitable for executing the methods disclosed herein;

FIG. 6 depicts a cloud computing environment in accordance with to at least one embodiment of the present invention; and

FIG. 7 depicts abstraction model layers in accordance with at least one embodiment of the present invention.

### DETAILED DESCRIPTION

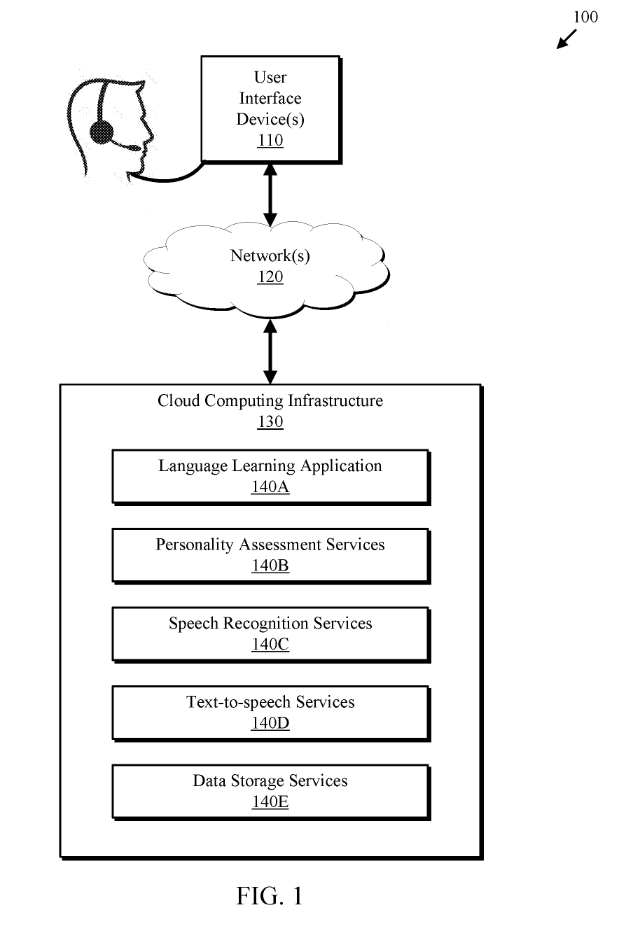

FIG. 1 is a block diagram depicting one example of a language learning environment 100 wherein at least one embodiment of the present invention may be deployed. As depicted, the language learning environment 100 includes one or more user interface devices 110, networks 120, a cloud computing infrastructure 130 and various cloud applications and services 140. The language learning environment 100 enables users of the user interface devices 110 to learn a language.

In the depicted example, the user interface devices 110 enable users to verbally communicate with a language learning application 140A. Examples of user interface devices 110 include phones, mobile phones, or computing devices with audio (e.g., speech) input capabilities. The user interface devices 110 may also support data communication over networks 120. Examples of networks 120 include telephone networks and computer networks including intra-networks and inter-networks.

In the depicted embodiment, users using the interface device(s) 110 and applications executing on behalf of those users are able to access services 140 hosted by the cloud computing infrastructure 130. In the depicted embodiment, those services include personality assessment services 140B, speech recognition services 140C, text-to-speech services 140D, and data storage services 140E. The applications executed on behalf of users may include the language learning application 140A.

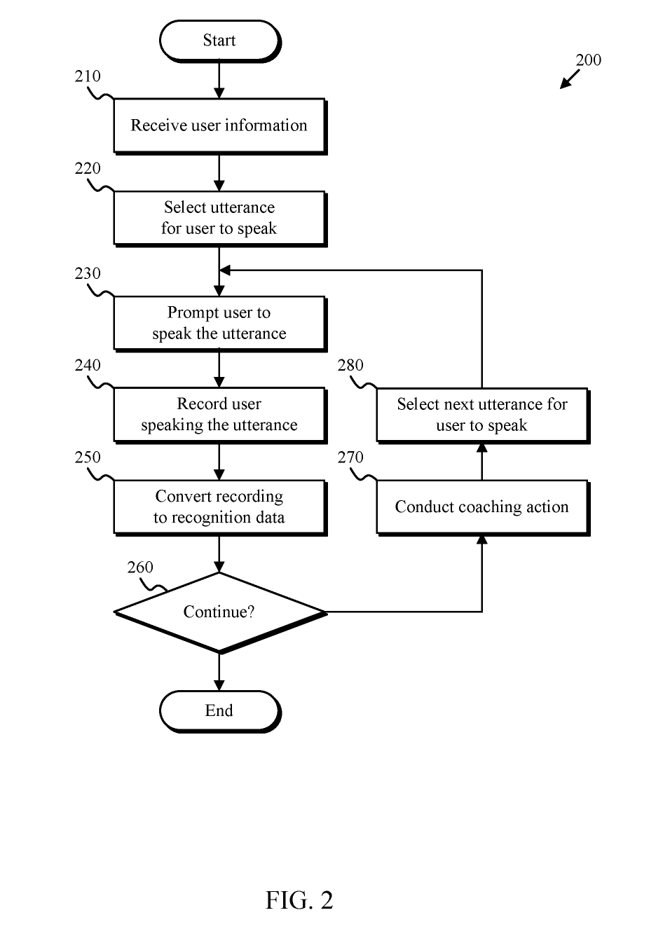

FIG. 2 is a flowchart depicting one example of a language learning method 200 in accordance with at least one embodiment of the present invention. As depicted, the language learning method 200 includes receiving (210) user information, selecting (220) an utterance, prompting (230) the user, recording (240) the user, converting (250) the recording to recognition data, determining (260) whether to continue, conducting (270) a coaching action, and selecting (280) a next utterance. The language learning method 200 may be conducted by the language learning application 140A or the like. The language learning application, or the like, may be executed on the cloud computing infrastructure 130 or some other type of computing infrastructure or device including partially or wholly on the user interface device 110.

Receiving (210) user information may include receiving user profile information such as language competency information, personality information, and user selected preferences. The personality information may be determined by conducting a personality analysis on text written by the user. For example, user written text may be collected from one or more sources such as writing samples, web pages, blogs, and social media content. One example of a personality assessment service suitable for determining personality information from user written text is known as “Personality Insights” and can be accessed at http://www.ibm.com/watson/developercloud/personality-insights.html.

Selecting (220) an utterance may include assessing a competency level for a current topic and selecting an utterance from a library of utterances based on the current topic, the competency level of the current topic, and the user profile information. For example, an initial utterance may be selected based on the language competency of the user and the personality information. The personality information may include a score or weighting for various personality attributes (measured characteristics) such as openness, adventurousness, artistic interest, emotionality, imagination, intellect, authority-challenging, conscientiousness, achievement striving, cautiousness, dutifulness, orderliness, self-discipline, self-efficacy, extraversion, activity level, assertiveness, cheerfulness, excitement-seeking, outgoing, gregariousness, agreeableness, altruism, cooperation, modesty, uncompromising, sympathy, trust, emotional range, fieriness, propensity to worry, melancholy, immoderation, self-consciousness, susceptible to stress, needs, challenge, closeness, curiosity, excitement, harmony, ideal, liberty, love, practicality, self-expression, stability, structure, values, conservation, openness to change, hedonism, self-enhancement, and self-transcendence.

Prompting (230) the user may include prompting the user to speak the utterance. In some embodiments, written text corresponding to the utterance is displayed to the user. In one embodiment, the user can also request to hear the utterance (e.g., via a digital recording or a text-to-speech utility).

Recording (240) the user may include recording a spoken response provided by the user in response to the prompt to speak the utterance. Converting (250) the recording to recognition data may include receiving the recording of the user speaking the utterance and converting the recording to recognition data with a speech recognizer or speech recognition service. One of skill in the art will appreciate that the recorded speech provided by operation 240 for conversion to recognition data may be streamed so that only a portion of the spoken utterance actually resides within local working memory at any given moment of time.

The recognition data generated by operation 250 may include the recognized text (e.g., words), alternative text, confidence levels, keywords, recognition accuracy data, error count data, error rate data, speaking rate data, prosody information, and the like. Determining (260) whether to continue may include determining whether the user has elected to terminate or suspend learning. If the user has elected to terminate or suspend learning the method exits. Otherwise, the method continues by conducting (270) a coaching action. Conducting (270) a coaching action may include encouraging the user, aborting a current topic, providing pronunciation tips, prompting the user to provide information on their experience that can be used to select utterances, and the like. Conducting (270) a coaching action may not occur with each iteration of the method 200.

Selecting (280) a next utterance may include selecting a next action based on the recognition data and the personality profile of the user. The next action may be selected from a set of next actions. In one embodiment, the set of next actions includes repeating, rephrasing, contrasting, elaborating, summarizing, providing a different context, and adjusting a difficulty level. Selecting (280) a next utterance may also include determining which utterance from a library of utterances corresponds to the next action and the current utterance prompt.

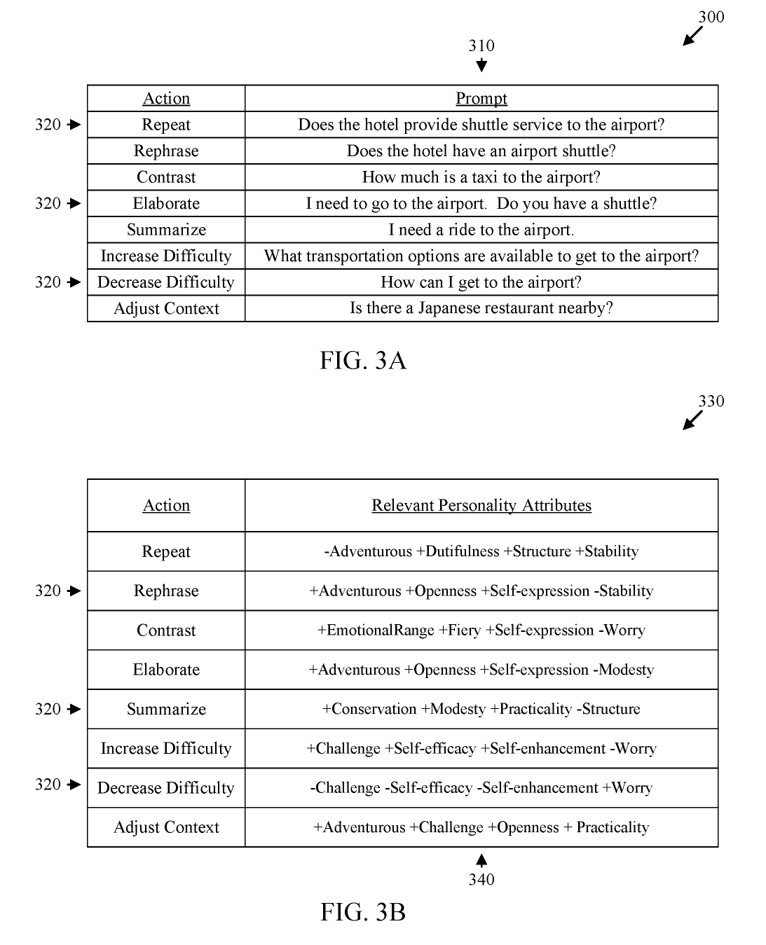

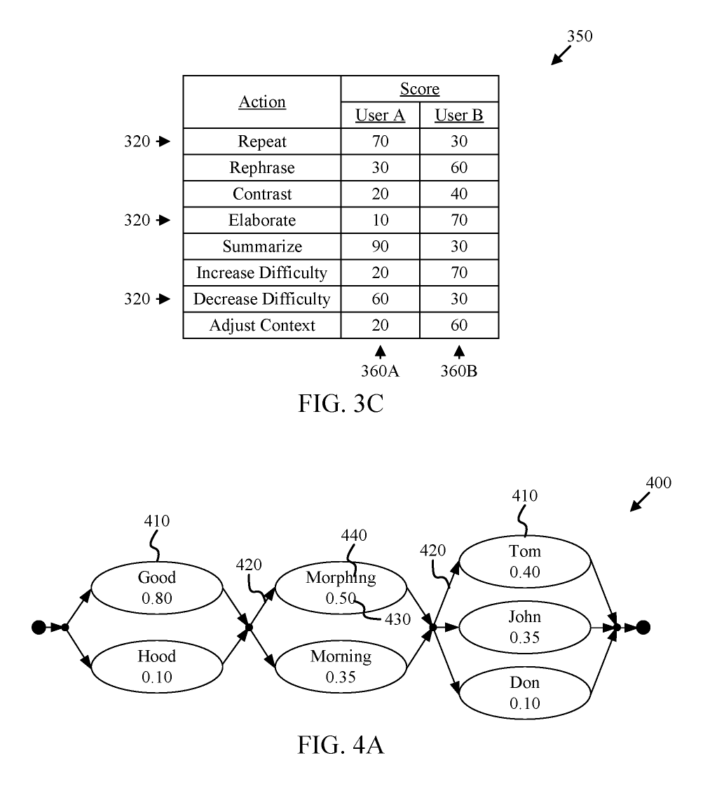

FIG. 3A is a table diagram depicting one example of a prompt table 300 in accordance with at least one embodiment of the present invention. As depicted, the prompt table 300 indicates a user prompt 310 for each action 320 of a set of next actions. The prompt table facilitates automated learning while providing multiple options for the language learning experience. The next action that is selected may be based on the recognition data and the personality profile of the user.

FIG. 3B is a table diagram depicting one example of a relevant attributes table 330 in accordance with at least one embodiment of the present invention. The relevant attributes table 330 indicates which personality attributes 340 are relevant to determining which next actions 320 are preferably used for particular users. The relevant attributes 340 may be personality attributes that positively (prepended with a ‘+’) or negatively (prepended with a ‘−’) correlate with each possible next action 320. Personality attributes with a negative correlation may be complemented or inverted. For example, the score or weight of an attribute with a negative correlation (e.g., 0.40) may be subtracted from a maximum score or weight to yield a score or weight (e.g., 1.00−0.40=0.60) that is used to determine which next actions are preferred for a particular user.

In some embodiments, the positive and negative correlations for each combination of next action 320 and personality attribute 340 are determined from a corpus of data collected from previous language learning sessions with various users. For example, learning success metrics (e.g., improvements in recognition rates) may collected for many users with various personality attributes. The learning success metrics can be correlated with the personality attributes and the selected next actions to determine the combination of personality attributes 340 and next actions 320 that most strongly correlate with success. Alternately, the relevant personality attributes 340 may be selected by those of skill in the art (or related arts) or selected via a trial and error process.

FIG. 3C is a table diagram depicting one example of a next action scoring table 350 in accordance with at least one embodiment of the present invention. The next action scoring table 350 indicates which next actions 320 are preferred for specific users via a next action score 360. In one embodiment, the next action score 360 is determined by summing or averaging personality attribute scores for a user for personality attributes that are determined to be relevant to each possible next action 320 (e.g., the relevant personality attributes 340). The next action scores 360 may be used to select between multiple potential next actions.

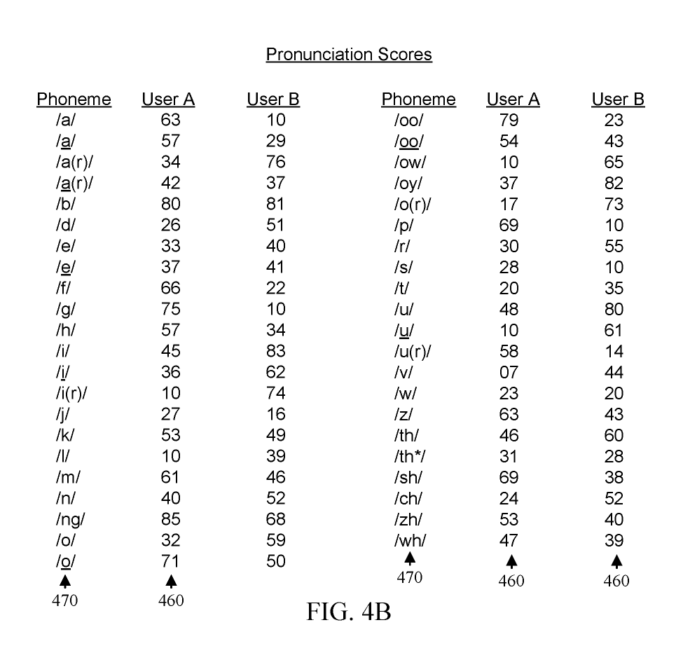

FIG. 4A is a speech recognition lattice 400 in accordance with at least one embodiment of the present invention. As depicted, the speech recognition lattice 400 includes a set of nodes 410 and directed edges 420. The nodes 410 and directed edges 420 indicate the possible utterances that a user articulated for a segment of speech. Each node 410 indicates a weight or confidence 430 for a unit of speech articulation 440 (e.g., phonemes or words) which in the depicted example is words. The speech recognition lattice 400 can be used to determine how well a user spoke an utterance which they were prompted to speak. For example, the weights for the nodes 410 that correspond to the prompted utterance can be used to compute a score for the user speaking the prompted utterance. The score for the user speaking the prompted utterance may be normalized and used to determine how well the user articulated the prompted utterance. Consequently, a next action and corresponding prompt may be determined based on both the accuracy of the recognized speech and the personality of the user.

FIG. 4B is a table diagram depicting one example of user pronunciation scores in accordance with at least one embodiment of the present invention. In one embodiment, speech recognition data from multiple utterances is collected to determine pronunciation scores 460 for units of speech articulation 470 which in the depicted example is phonemes. The pronunciation scores 460 can be used in conjunction with personality information to select utterance prompts that expedite the language learning process. For example, with personalities that are adventurous or like a challenge, utterance prompts may be selected that include units of speech articulation 470 for which the user has low scores. In contrast, with personalities that worry or do not like a challenge, utterances may be avoided that include units of speech articulation 470 for which the user has low scores.

One of skill in the art will appreciate that the embodiments disclosed herein enable a customized language learning experience without requiring previous language learning interaction with a user. Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowcharts and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

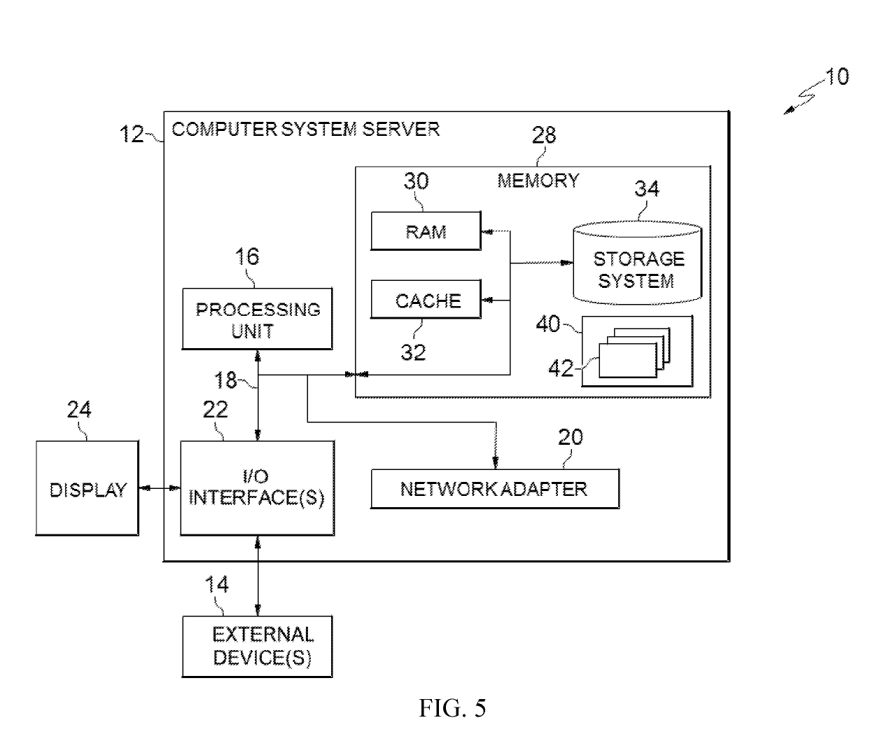

Referring now to FIG. 5, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 5, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

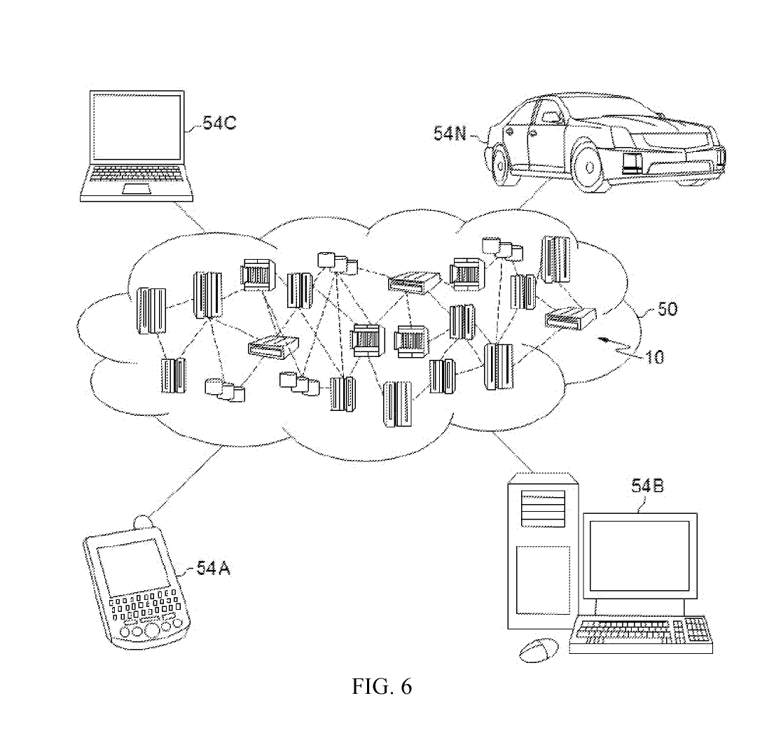

Referring now to FIG. 6, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 6 are intended to be illustrative only and that computing nodes 10 and cloud computing environment 50 can communicate with any type of computerized device over any type of network and/or network addressable connection (e.g., using a web browser).

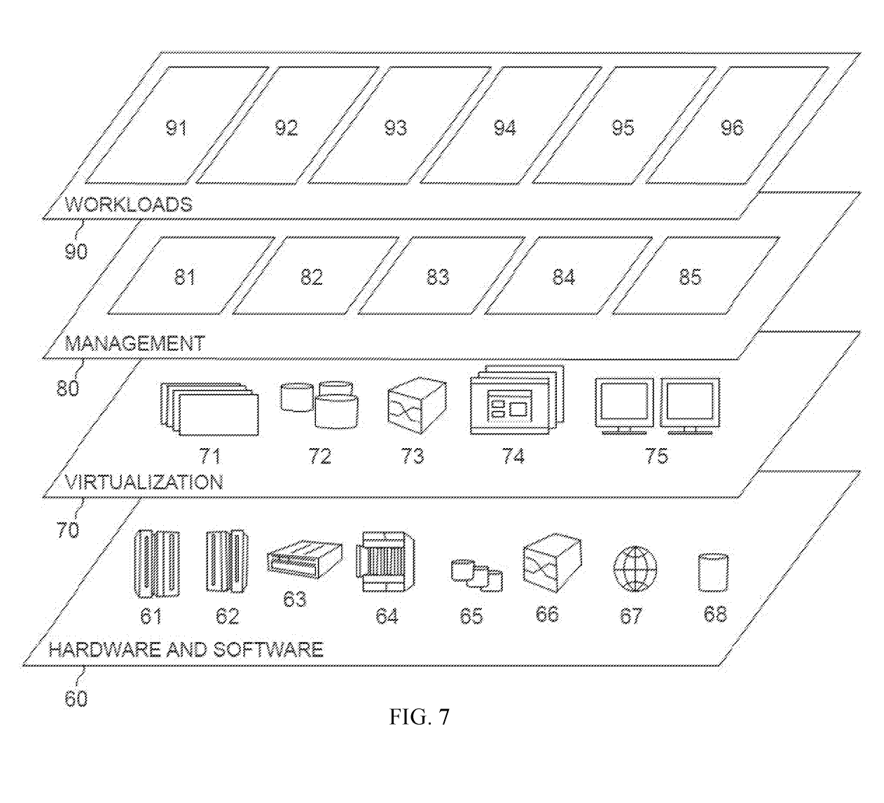

Referring now to FIG. 7, a set of functional abstraction layers provided by cloud computing environment 50 (FIG. 6) is shown. It should be understood in advance that the components, layers, and functions shown in FIG. 7 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and deployed enterprise application 96.

It should be noted that this description is not intended to limit the invention. On the contrary, the embodiments presented are intended to cover some of the alternatives, modifications, and equivalents, which are included in the spirit and scope of the invention as defined by the appended claims. Further, in the detailed description of the disclosed embodiments, numerous specific details are set forth in order to provide a comprehensive understanding of the claimed invention. However, one skilled in the art would understand that various embodiments may be practiced without such specific details.

Although the features and elements of the embodiments disclosed herein are described in particular combinations, each feature or element can be used alone without the other features and elements of the embodiments or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

1. A method, executed by one or more processors, the method comprising:
determining a plurality of measured personality characteristics for a user from user written text using a personality assessment service executing on a server;
prompting the user to speak an utterance comprising one or more words, wherein the utterance is selected from a library of utterances based on the plurality of measured personality characteristics for the user; and
converting a recording of the user speaking the utterance to recognition data with a computer-based speech recognizer.

2. The method of claim 1, further comprising selecting a next utterance based on the recognition data and the plurality of measured personality characteristics for the user.

3. The method of claim 2, wherein the next utterance is selected from the library of utterances.

4. The method of claim 2, wherein the next utterance corresponds to a next action selected from the group consisting of repeating, rephrasing, contrasting, elaborating, summarizing, providing a different context, and adjusting a difficulty level.

5. The method of claim 2, further comprising conducting a coaching action in conjunction with selecting the next utterance.

6. The method of claim 5, wherein the coaching action comprises aborting a current topic or encouraging the user.

7. The method of claim 1, wherein the plurality of measured personality characteristics comprises a measured characteristic selected from the group consisting of openness, adventurousness, artistic interest, emotionality, imagination, intellect, authority-challenging, conscientiousness, achievement striving, cautiousness, dutifulness, orderliness, self-discipline, self-efficacy, extraversion, activity level, assertiveness, cheerfulness, excitement-seeking, outgoing, gregariousness, agreeableness, altruism, cooperation, modesty, uncompromising, sympathy, trust, emotional range, fieriness, propensity to worry, melancholy, immoderation, self-consciousness, susceptible to stress, needs, challenge, closeness, curiosity, excitement, harmony, ideal, liberty, love, practicality, self-expression, stability, structure, values, conservation, openness to change, hedonism, self-enhancement, and self-transcendence.

8. The method of claim 7, wherein the measured characteristic is determined from one or more of a writing sample, a web page, a blog, and a social media site.

9. The method of claim 1, wherein the recognition data comprises one or more of recognized text, alternative text, keywords, recognition accuracy data, error count data, error rate data, speaking rate data, and prosody information.

10. A computer system comprising:
one or more computer processors;
one or more computer readable storage media that are not transitory signals per se and program instructions stored on the one or more computer readable storage media, the program instructions comprising instructions to perform a method comprising:
determining a plurality of measured personality characteristics for a user from user written text using a personality assessment service executing on a server;
prompting the user to speak an utterance comprising one or more words, wherein the utterance is selected from a library of utterances based on the personality profile for the user; and
converting a recording of the user speaking the utterance to recognition data with a computer-based speech recognizer.

11. The computer system of claim 10, wherein the method further comprises selecting a next utterance based on the recognition data and the plurality of measured personality characteristics for the user.

12. A computer product comprising:
one or more computer readable storage media that are not transitory signals per se and program instructions stored on the one or more computer readable storage media, the program instructions comprising instructions to perform a method comprising:
determining a plurality of measured personality characteristics for a user from user written text using a personality assessment service executing on a server;
prompting the user to speak an utterance comprising one or more words, wherein the utterance is selected from a library of utterances based on the plurality of measured personality characteristics for the user; and
converting a recording of the user speaking the utterance to recognition data with a computer-based speech recognizer.

13. The computer program product of claim 12, wherein the method further comprises selecting a next utterance based on the recognition data and the plurality of measured personality characteristics for the user.

14. The computer program product of claim 13, wherein the next utterance is selected from the library of utterances.

15. The computer program product of claim 13, wherein the next utterance corresponds to a next action selected from the group consisting of repeating, rephrasing, contrasting, elaborating, summarizing, providing a different context, and adjusting a difficulty level.

16. The computer program product of claim 13, wherein the method further comprises conducting a coaching action in conjunction with selecting the next utterance.

17. The computer program product of claim 16, wherein the coaching action comprises aborting a current topic or encouraging the user

18. The computer program product of claim 12, wherein the plurality of measured personality characteristics comprises a measured characteristic selected from the group consisting of openness, adventurousness, artistic interest, emotionality, imagination, intellect, authority-challenging, conscientiousness, achievement striving, cautiousness, dutifulness, orderliness, self-discipline, self-efficacy, extraversion, activity level, assertiveness, cheerfulness, excitement-seeking, outgoing, gregariousness, agreeableness, altruism, cooperation, modesty, uncompromising, sympathy, trust, emotional range, fieriness, propensity to worry, melancholy, immoderation, self-consciousness, susceptible to stress, needs, challenge, closeness, curiosity, excitement, harmony, ideal, liberty, love, practicality, self-expression, stability, structure, values, conservation, openness to change, hedonism, self-enhancement, and self-transcendence.

19. The computer program product of claim 18, wherein the measured characteristic is determined from one or more of a writing sample, a web page, a blog, and a social media site.

20. The computer program product of claim 12, wherein the recognition data comprises one or more of recognized text, alternative text, keywords, recognition accuracy data, error count data, error rate data, speaking rate data, and prosody information.
